(19) United States
(12) Patent Application Publication
(10) Pub. No.: US 2009/0262086 A1
(43) Pub. Date: Oct. 22, 2009

(54) Touch-pad cursor control method

(75) Inventor: Stephen Chen, Changhua (TW)

Correspondence Address: ROGER H. CHU, 19499 ERIC DRIVE, SARATOGA, CA, 95070, US

(73) Assignee: E-LEAD ELECTRONIC CO., LTD., Shengang Shiang (TW)

(21) Appl. No.: 12/107,073

(22) Filed: Apr. 22, 2008

(51) Int. Cl. G06F 3/041

(52) U.S. Cl. 345/173

(57) ABSTRACT

A touch-pad cursor control method is discussed. The touch-pad invention is placed in an electronic device and its control method is comprised of steps detecting if an object contacts the touch-pad; detecting the location of the object contacting the touch-pad; examining if an input for quick cursor movement exists, if YES, dragging the cursor on the device's display to the corresponding location of the object on the touch-pad in absolute coordinate positioning, if NOT, mapping the moving distance and direction of the object on the touch-pad to the position of the cursor on the device's display in relative coordinate positioning; detecting if an input button of the electronic device is pressed; and finally, executing a command based on an item pointed by said cursor on the display. By basing cursor movement on touch-pad input in both absolute and relative coordinate positioning methods, the invention determines cursor location, achieving a fast moving cursor effect

### FIELD OF THE INVENTION

The present invention relates to a touch-pad cursor control method, specifically a method of controlling a touch-pad cursor that achieves faster cursor movement.

### BACKGROUND OF THE INVENTION

Generally, human-computer interaction is composed of a character input device and directional control device; while the character input device generally includes keyboards or hand writing devices, the directional control device is for controlling cursor movements. Such devices include mouses, joysticks, arrow keys, touch panels, touch-pads, etc. The aforementioned arrow keys and joysticks control the direction of cursor movement easily, but lack precise cursor speed control; consequently, such time-consuming operations have not been extensively applied in the field. In addition, it is more convenient for a user to use his/her finger on the edge of a mouse button to move the cursor around the screen; however, mouse movements require a lot of space, so that such applications are not suitable for a mobile notebook PC or a small electronic device. Nowadays, touch panels have been widely applied in various small electronic devices, but there are several disadvantages to using a finger or a touch pen. For example, the palm of hand usually hinders a user from screen views, the finger touch easily stains the screen, etc. Therefore, even though a small electronic device is equipped with a touch display, an additional pointing device is generally provided. Most modern notebook PCs have been equipped with touch-pads as standard pointing device applications, less space is required for operations and users are used to such arrangement, though existing touch-pad operations may not be as smooth as the use of a mouse.

A conventional touch-pad usually controls the cursor movements on the display in relative coordinate positioning, meaning the distance and direction of a user's finger movements on the touch-pad matter, while the actual location of the finger on the touch-pad is irrelevant. The cursor on the display is moved in the same direction as the finger movement over a scaled distance. This application is similar to mouse movement: if a targeted position on the display can not be reached by a single movement, the user's finger can be lifted and re-pointed at a position on the touchpad to move again; repeatedly pointing and moving the cursor allow the user to move the cursor to the desired point on the display.

If the finger movements are scaled aggressively, the cursor moves further without repeated finger motion; however, it is harder for a user to aim at a target location and move his/her finger around the screen accurately. If the finger movements are scaled more conservatively, it is easier for a user to aim at a target location and move his/her finger around the screen towards the location; however, it requires several finger motions to move the cursor towards the targeted location.

Using the speed of finger motion to decide the enlargement proportion addresses the aforementioned problem, i.e., a user may move quickly to aggressively scale and enable the cursor to move faster, or move slower (at a smaller scale) to aim at a target on the screen. This method slightly reduces the above problem of using a device with a touch-pad; nevertheless, such a method is unable to satisfy most users, who find frequent finger motion on the touch-pad inconvenient. Consequently, many users of notebook PCs with pre-installed touch-pad devices still use a supplementary mouse.

U.S. Pat. No. 5,327,161 is mainly with a touchpad input device having a drag switch and touch device (finger, stylus, etc.), in which the direction of movement of the touch device across the touchpad surface is determined, a display cursor is moved in the same relative direction as the touch device, allowing the cursor to be moved a greater distance than the touch device (i.e. moved more quickly and with greater sensitivity) without the need for multiple strokes/drags. However, the prior art of the U.S. Pat. No. 5,327,161 still has a practical problem of precisely pointing the cursor at an object on the screen due to sensitivity.

One method to reduce the problem uses the speed of the user's finger on the touch-pad to determine the enlargement scale. When a user's finger moves quickly, the motion is aggressively scaled and the cursor moves faster, while slower movements are more delicately scaled to aim at a target on the screen. This method slightly reduces the above problem of using a device with a touch-pad; however, such a method is unable to satisfy most users, who find frequent finger motion on the touch-pad inconvenient. Consequently, many users of notebook PCs with pre-installed touch-pad devices still use a supplementary mouse; since an additional portable mouse is required, the touch-pad design is superfluous.

Consequently, enabling a user to utilize a touch-pad without inconvenience is a practical concern to be considered.

### SUMMARY OF THE INVENTION

The invention, a touch-pad cursor control method that facilitates fast cursor movement, aims to address the shortcomings of conventional techniques.

To achieve this, the invention provides a touch-pad cursor control method, using a touch-pad placed in an electronic device; the control method is comprised of the following steps:

The first step is to detect if an object is in contact with the touch-pad, the next step is to calculate the location coordinates of the object touching the touch-pad, the next step is to examine if the signal requirement for quick cursor movement exists. If such input exists, the next step includes canceling said input, then moving the cursor around the device's display to the location corresponding to the object touching the touch-pad in absolute coordinate positioning; in this case, the location of the cursor is determined by the location of the object on the touch-pad, when the input object touches a point on the touch-pad, the cursor is subsequently moved to the same relative location on the display screen at once. If the input for quick cursor movement does not exist, the distance and direction of the input motion around the touch-pad corresponds to the location of the cursor on the device's display in relative coordinate positioning. Therefore, the step enables the cursor on the display to be quickly moved near the selection item (ICON) in absolute coordinate positioning; then, slight movements of the cursor in relative coordinate positioning allows for precise aim at the selection item. The next step is to detect if an input button is pressed and the final step is to execute the command of the item selected by the cursor on the display.

The above method of absolute coordinate positioning contacts coordinate positioning of the screen scale with relevant coordinate positioning of the touch-pad one by one, multiplies each location coordinate of the touch-pad by a specific enlargement ratio to get each correspondent location of the cursor on the display, in addition, the enlargement proportion is determined by respective lengths and widths of the touch-pad and of the display. For example, the upper left corner of the touch-pad is correspondent with the upper left corner of the screen and the lower right side of the touch-pad is correspondent with the lower right side of the screen. The above method in relative coordinate positioning means that the location coordinates of the touch-pad is not directly related to the location coordinates of the screen, in addition, the location and movement of the cursor on the screen is irrelevant to the location of the object on the touch-pad, but is related to the movement of the object on the touch-pad, so that the location and movement of the cursor on the screen is determined by the operation of the object on the touch-pad in both absolute and relative positioning, therefore, the invention is able to achieve the effects of fast cursor moving on the screen and easy icon pointing without the problems and inconvenience caused to a user to repeatedly drag the cursor and rub against the touch-pad.

Another embodiment of the invention discloses a touch-pad cursor control method, using the touch-pad placed in an electronic device, the control method is comprised of the following steps:

detecting if an object contacts the touch-pad;

detecting if the object contacts the location coordinates of the touch-pad and moving said cursor on the device's display towards the correspondent location of the object on the touch-pad in absolute coordinate positioning;

determining if the object still contacts the touch-pad;

moving the cursor location on the device's display based on the distance and direction of moving the object on the touch-pad in relative coordinate positioning; detecting if an input button of the electronic device is pressed; and finally executing the command of the selected item pointed by the cursor on the display.

The invention enables the location of moving the cursor on the screen to be determined based on the location of moving the object in absolute and relative coordinate positioning, so as to achieve the objective of fast moving the cursor without the problems and inconvenience caused to a user to repeatedly drag the cursor and rub against the touch-pad. A first embodiment of the invention is therefore disclosed herein. The touch-pad activates an input for quick cursor movement and executes relevant commands and calculations in absolute coordinate positioning each time when the object is lifted and re-pointed at the same location on the touch-pad.

A detailed description is given in the following embodiments with reference to the accompanying drawings.

### BRIEF DESCRIPTION OF THE DRAWINGS

The invention can be more fully understood by reading the subsequent detailed description and examples with reference to the accompanying drawings:

FIG. 1 is a flow chart showing a touch-pad cursor control method;

FIG. 2 is a flow chart showing the movements of the invention's touch-pad cursor;

FIG. 3 is another flow chart showing the movements of the touch-pad cursor in accordance with the invention;

FIG. 4 is an illustrative view showing a preferred embodiment of a touch-pad cursor control method in accordance with the invention;

FIG. 5 is an illustrative view showing a preferred embodiment of a touch-pad cursor control method in accordance with the invention;

FIG. 6 is an illustrative view showing another preferred embodiment of a touch-pad cursor control method in accordance with the invention;

FIG. 7 is an illustrative view showing another preferred embodiment of a touch-pad cursor control method in accordance with the invention;

FIG. 8 is an illustrative view showing another preferred embodiment of a touch-pad cursor control method in accordance with the invention; and

FIG. 9 is a flow chart showing the movements of a touch-pad cursor control method in accordance with the invention.

### DETAILED DESCRIPTION OF THE INVENTION

The invention discloses a touch-pad cursor control method herein. Prior to introduction to the invention's method, the design and concept of the invention is described as follows. Generally, a user uses his/her finger or a touch pen to point on a touch panel product, the cursor is moved to relevant location on the display; whereas when a user uses his/her finger to move around the touch-pad, the cursor is then moved on the display. The invention is therefore applies the advantages of both touch panel screen and touch-pad to disclose a convenient method for users.

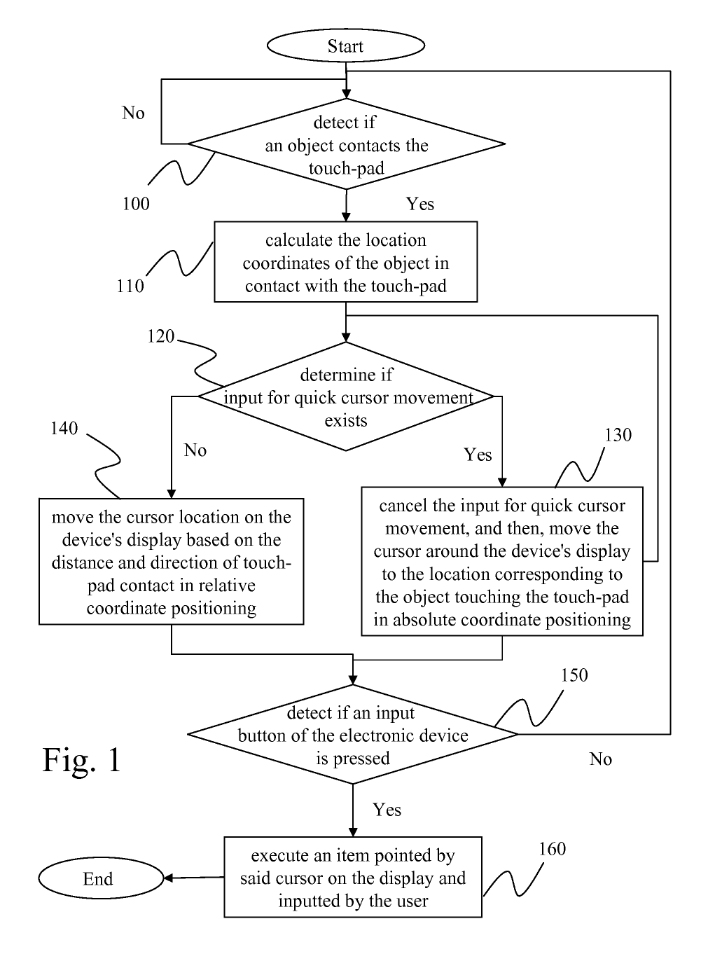

FIG. 1 is a flow chart of the invention's touch-pad cursor control method. The invention's touch pad is placed in an electronic device, (here, a notebook computer, but application is not limited to notebook computers, any kind of electronic device that allows data input could use it). The control method involves the following steps. The first step is to detect if an object is in contact with the touch-pad (Step 100); the object in a preferred embodiment of the invention is either a user's finger, a touch pen or other substitute that is able to point on the touch-pad to control the cursor movement. If the touch-pad does not detect any contact from any object, the cursor on the screen does not move, and the touch-pad repeatedly executes Step 100 for detecting till the electronic device is turned off. If contact is detected, the next step is to calculate the location coordinates of the object on the touch-pad (Step 110); then, the next step is to determine if input for quick cursor movement exists (Step 120). If so, the step includes canceling the input for quick cursor movement, and then, moving the cursor around the device's display to the location corresponding to the object touching the touch-pad in absolute coordinate positioning (Step 130); here, the location of the cursor is determined by the location of the object on the touch-pad, when the object contacts a location on the touch-pad, the cursor is subsequently moved to a relative location on the display screen at once. If any slight adjustment of location coordinates is required, the step returns to Step 120.

If the input for quick cursor movement does not exist, the step is to move the location of the cursor on the device's display based on the distance and direction of the object moving around the touch-pad in relative coordinate positioning (Step 140). The distance and direction of cursor movement and the ratio of this distance and direction on the touch-pad to that of the display is obviously less than the ratio of the width and the length of the display to that of the touch-pad, in order to achieve more precise results.

Step 130 enables the cursor on the display to be quickly moved near the selection item (ICON) in absolute coordinate positioning; the step includes continuously detecting if a input for quick cursor movement exists, if NOT, Step 140 slightly adjusts the cursor in relative coordinate positioning to allow the cursor to accurately move toward the selection item.

The next step is to detect if an input button of the electronic device is pressed (Step 150), if NOT, the user is not attempting to execute the command pointed at by the cursor on the display, the flow then goes back to Step 100 and continuously detects if an object contacts the touch-pad, and determines to move the cursor in relative or in absolute coordinate positioning. If the input button of the electronic device is pressed, a user intends to execute the selected item; the step is to execute the command of the selected item pointed by the cursor on the display (Step 160), the flow then ends.

The above method of absolute coordinate positioning contacts coordinate positioning of the screen scale with relevant coordinate positioning of the touch-pad one by one, multiplying each location coordinate of the touch-pad by a specific enlargement ratio to determine each correspondent location of the cursor on the display, in addition, the enlargement proportion is determined by respective lengths and widths of the touch-pad and of the display. Absolute coordinate positioning also enables the location of the cursor to be determined by the actual location of the object on the touch-pad. For example, the upper left corner of the touch-pad corresponds with the upper left corner of the screen and the lower right side of the touch-pad corresponds with the lower right side of the screen. Relative coordinate positioning means that the location coordinates of the touch-pad are not directly related to the location coordinates of the screen, in addition, location of the cursor on the screen is not related the location of the object on the touch-pad, but the cursor's movement is directly related to the movement of the object on the touch-pad. The location and movement of the cursor on the screen is determined by the operation of the object on the touch-pad in both absolute and relative coordinate positioning, therefore, the invention is able to achieve the effects of fast cursor movement on the screen and easy icon pointing without the problems and inconvenience of repeated dragging motions on the touchpad.

The above step of examining if input for quick cursor movement exists is triggered by a user, therefore, the invention design enables a stand-alone key button for a user to press down and activate the input, or allows a user to map a motion to the touch-pad, such as clicking or double clicking, in order to activate the signal requirement. As the signal is a one-time request, if the signal requirement exists, the flow first cancels the signal requirement, and then, moves the cursor around the device's display to the location corresponding to the object touching the touch-pad in absolute coordinate positioning (Step 130). In this case, absolute coordinate positioning is similar to the concept of touch panel display, in which a user's finger or a touch pen points at a location on the touch-pad and the cursor is moved to the location on the display; therefore, when a finger or a touch pen points at the center of the touch-pad, the cursor is located on the center of the display screen; or when a finger or a touch pen points at a corner on the touch-pad, the cursor is moved to a corresponding location on the display. The cursor can move large distances on the display but the user's finger need not make repeated motions on the touchpad. The subsequent step is to examine if another input for quick cursor movement exists. If NOT, the step is to move the cursor on the device's display based on the distance and direction of the object moving around the touch-pad in relative coordinate positioning (Step 140). If a user's finger or a stylus moves around the touch-pad, the cursor is moved a proportionate distance; the proportion is normally designed within a specific range, to allow the user to easily make slight adjustments to the cursor's position on the screen towards the targeted location. During the command execution or after the completion of the flow, the touch-pad controls the movement of the cursor on the display or terminates the operation of the electronic device; therefore, the flow of the invention goes back to Step 100 to determine whether to move the cursor in relative or in absolute coordinate positioning.

The above method is able to control the cursor in relative coordinate positioning and enables a user to point at an aimed item (ICON) with the touch-pad by using the cursor immediately, if the cursor is close to the aimed item; however, if the cursor is far away from the aimed item, moving the cursor location in relative coordinate positioning requires a user to make repeated motions on the touch-pad. When a input for quick cursor movement is triggered, the invention enables the object touching the touch-pad to be roughly correspondent with the location of a target on the screen in absolute coordinate positioning, the cursor on the display is immediately moved near the location of the target, subsequently, the invention slightly adjusts the location in relative coordinate positioning to enable the cursor to accurately point at any selected target on the screen.

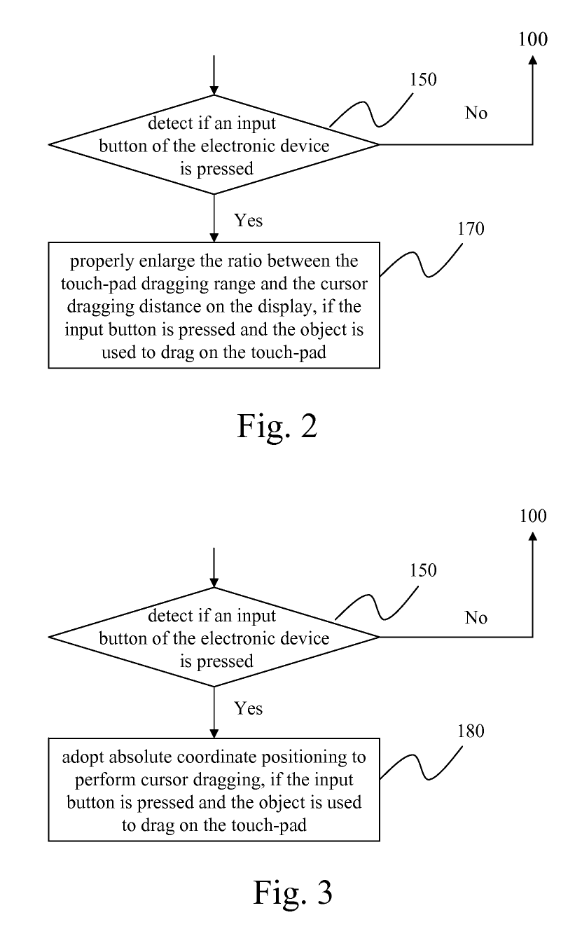

Moreover, the cursor performs a “dragging” function in existing operation systems (namely, selection). For example, if a user wants to select a paragraph from an article, the user holds down the left mouse button and moves the cursor on the display screen from the beginning of the paragraph to be selected to its end. If a user wants to drag the scrollbar on the screen, the user usually holds the left mouse button and “drags” the cursor to the bottom or top. When a user drags the cursor on a touch-pad to select a paragraph that is too large to be viewed on-screen, he/she can perform similar cursor dragging functions, however, the user may need to repeatedly drag the cursor on the touch-pad to select the whole paragraph as the cursor dragging distance is almost the same as the moving distance of the cursor on the screen. Such cursor dragging (selection) is able to be achieved by invention's touch-pad cursor control method as shown in FIG. 2. When the cursor on the screen is moved to a target location, the invention's method determines if an input button of an electronic device is pressed, if NOT, the invention re-starts Step 100; if the input button is pressed and the object (a finger or a touch pen) is used to drag on the touch-pad, the invention enlarges the ratio between the touch-pad dragging range and the cursor dragging distance on the display (Step 170), thereby enabling a smaller touch-pad dragging range to perform a bigger cursor dragging distance, so as to allow an enlarged cursor dragging range for selection. With reference to FIG. 3, when an input button is pressed and the object (a finger or a touch pen) is used to drag on the touch-pad, the invention adopts absolute coordinate positioning to perform cursor dragging (Step 180), the step shows another application to enlarge the ratio between the dragging range and the cursor dragging distance on the display screen. By using the absolute coordinate positioning, the invention enables cursor dragging to reach any location on the display screen.

This is deemed a special case of the first case, wherein each time an object is lifted and re-pointed on the touch-pad, such motion is deemed a signal request for quick cursor movement, and the invention calculates the location in absolute coordinate positioning.

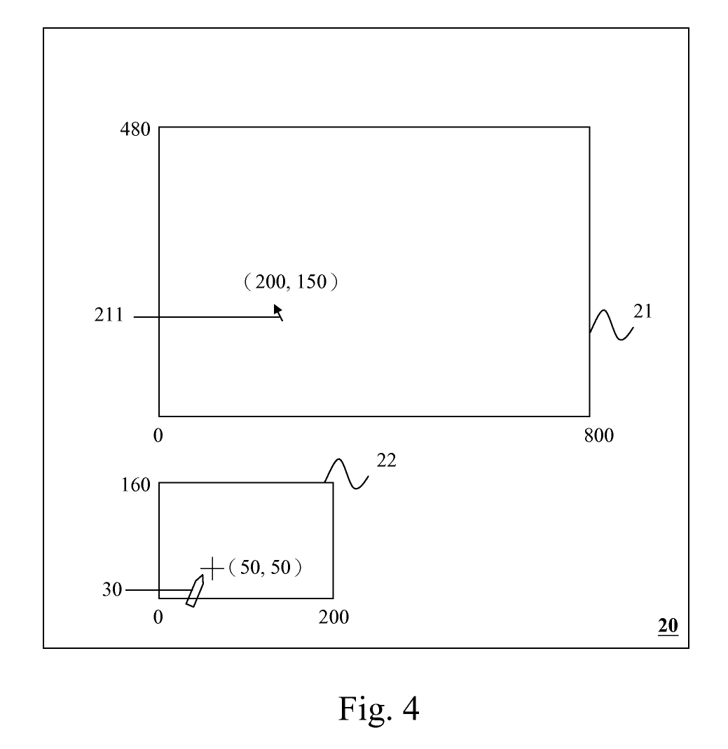

With reference to FIG. 4, another preferred embodiment of the touch-pad cursor control invention's method in absolute coordinate positioning shows that an electronic device 20, for example a notebook computer, is comprised of a display screen 21 and a touch-pad 22. The length of the display screen 21 (800×480) is four times of that of the touch-pad 22 (200×160), the height of the display screen 21 is three times of that of the touch-pad 22, therefore, the enlargement proportion is 4:3. In Step 130, when an object 30 (a finger or a touch pen) contacts the touch-pad 22 (50, 50) in absolute coordinate positioning, the location coordinates of a cursor 211 on the display screen 21 have a length four times the length of the location coordinates of the touch-pad 22, and a width three times the width of the location coordinates of the touch-pad 22, i.e., (200, 150) in absolute coordinate positioning. Therefore, no matter what the coordinates of the object 30 location on the touch-pad 22 are, the invention multiplies their length by 4 and their height by 3 to determine the coordinates of the cursor 211 on the display screen 21.

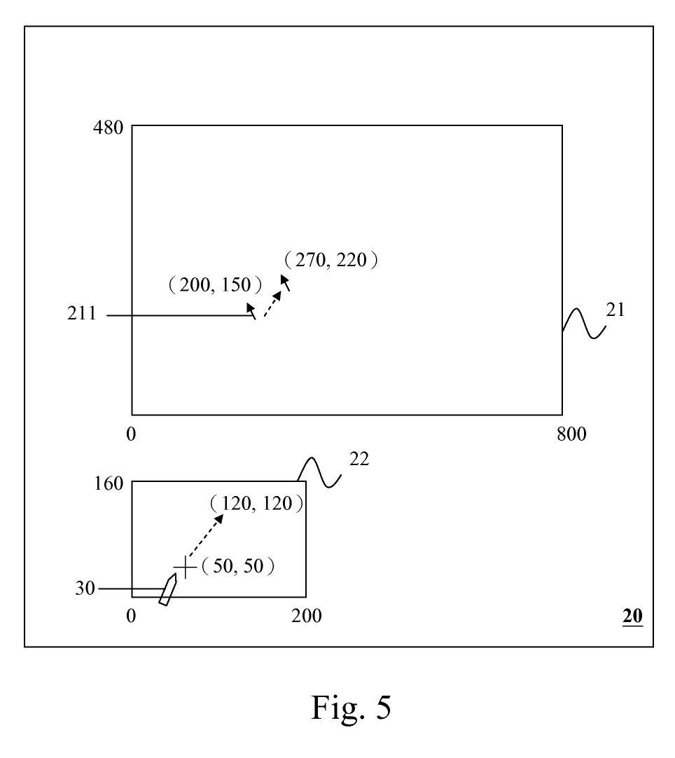

FIG. 5 shows another embodiment of the invention in relative coordinate positioning. In Step 140, when the object 30 (a finger or a stylus) is moved (dragged) from the location coordinates of the touch-pad 22 (50, 50) to (120, 120), the distance traveled is (70, 70). By using relative coordinate positioning, the invention adds up the location coordinates of the cursor 211 (200, 150) on the display screen 21 and coordinates of (70, 70) and gets the location coordinates of (270, 220); therefore, the dragging distance of the object 30 is equal to the moving distance of the cursor 211 on the display screen 21; this is absolute coordinate positioning. If the coordinates of the touch-pad 22 is moved about (70, 70), the coordinates of the cursor 211 on the display screen 21 is also moved about (70, 70), meaning that the enlargement ratio is (1, 1); if the coordinates of the touch-pad 22 is moved about (70, 70) and the coordinates of the cursor 211 on the display screen 21 is moved about (105, 105), meaning that the enlargement ratio is (1.5, 1.5). Therefore, when a user wants to select a paragraph, an enlargement ratio of (1.5, 1.5) is applied to the cursor 211 on the display screen 21. The invention enables a user to make larger and more practical cursor movement. Moreover, the enlargement ratio of (4, 3) according to the invention allows same control as in absolute coordinate positioning using in Step 180.

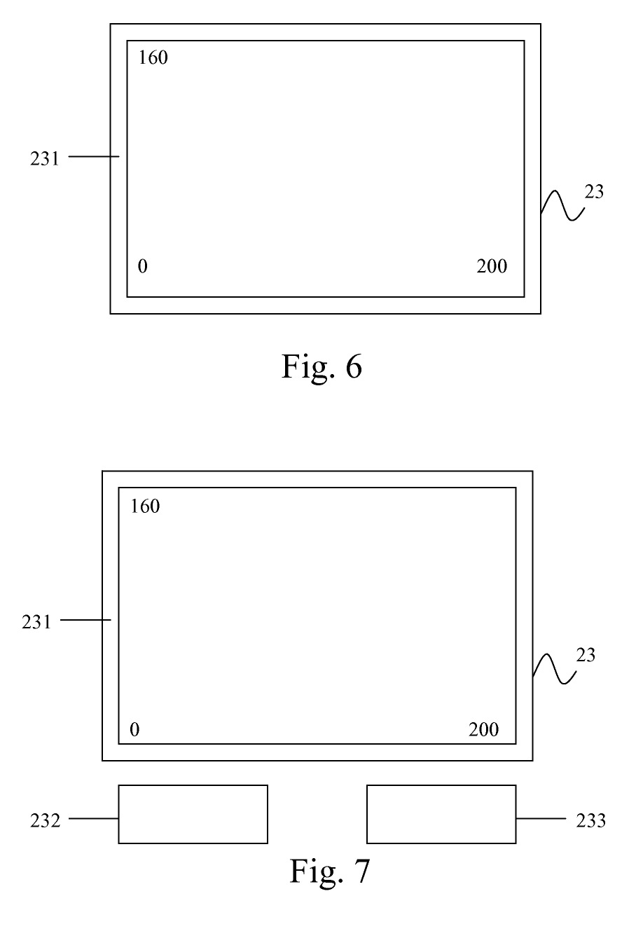

With reference to FIG. 6, another ideal embodiment of the invention shows that the peripheral of the touch-pad 22 is equipped with a movement control area 231.

With reference to FIG. 7, another preferred embodiment of the invention shows input buttons 232 and 233 of the invention, similar to left and right mouse buttons, positioned below a touch-pad 23 for a user to select the location pointed by the cursor or execute other command.

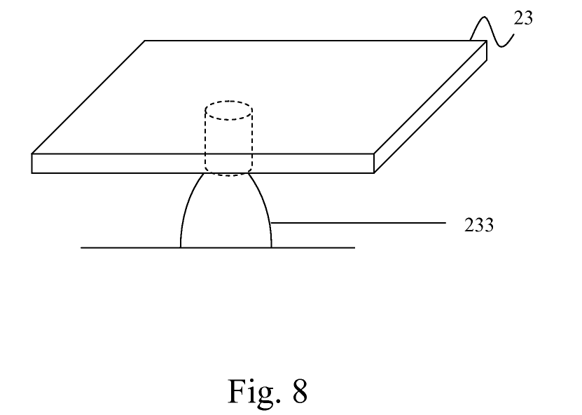

With reference to FIG. 8, another preferred embodiment of the invention shows an input button 233, which functions like a left mouse key and is positioned on the lower surface inside touch-pad 23 for executing click cursor commands. Input button 233 detects the movement of a finger or a touch pen in contact with the touch-pad, and the invention performs inputted command or other operation as pointed by the cursor based on a specific value (normally bigger than the pressure of pressing the input button).

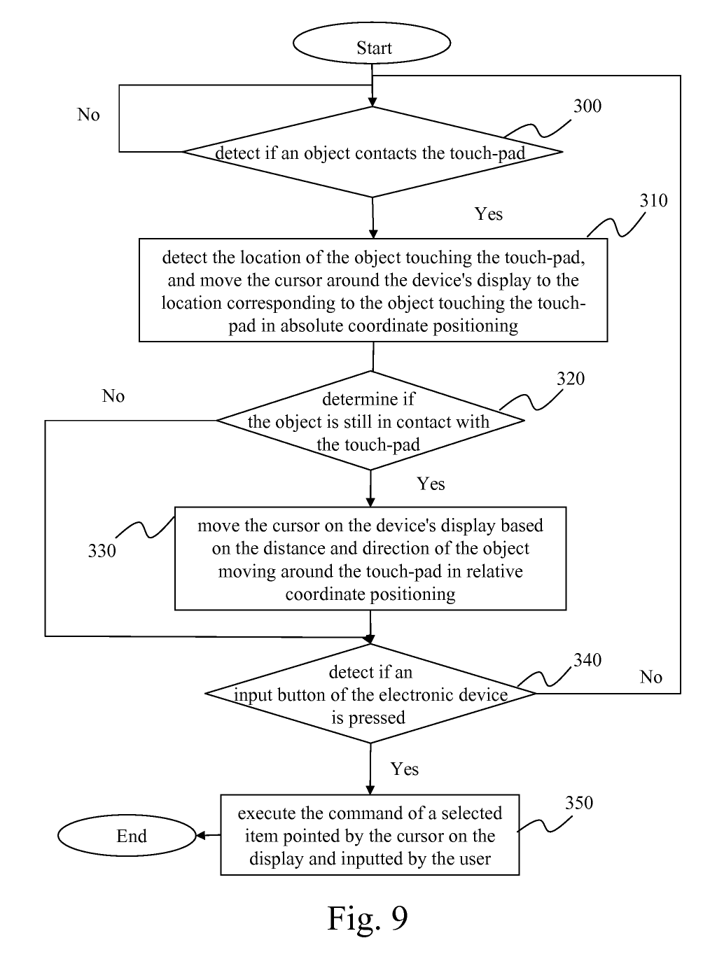

FIG. 9 is a flow chart showing the movements of the invention's touch-pad cursor control method as follows.

The invention provides a touch-pad cursor control method, using a touch-pad placed in an electronic device, which is given an example as a notebook computer, but is not limited to notebook computer only, any kind of electronic device that allows data input is deemed applicable. The control method is comprised of the following steps. The first step is to detect if an object contacts the touch-pad (Step 300), the object in this preferred embodiment of the invention is a user's finger, a touch pen, or other object that is able to point on the touch-pad to control the cursor's movement. If the touch-pad does not detect contact with any object, the cursor on the screen does not move, and the touch-pad repeatedly executes Step 300 to detect contact until the electronic device is turned off; If any contact is detected, the next step is to detect the location of the object touching the touch-pad and move the cursor around the device's display to a corresponding location in absolute coordinate positioning (Step 310). This is similar to the concept of touch panel display, in which a user's finger or a touch pen points at a location on the touch-pad and the cursor is moved to a corresponding location on the display; therefore, when a finger or a touch pen points at the center of the touch-pad, the cursor is located on the center of the display screen; or when a finger or a touch pen points at a corner on the touch-pad, the cursor is moved to a correspondent location on the display. Consequently, the instant moving distance of the cursor is large on the display, absolute coordinate positioning scales the location coordinates of the touch-pad at a specific ratio to determine a correspondent location of the cursor on the display (the enlargement ratio is determined by respective lengths and widths of the touch-pad and the display screen). Absolute coordinate positioning also enables the motion of the cursor around the display to be determined by the actual location of the object on the touch-pad. The next step is to determine if the object is still in contact with the touch-pad (Step 320), if NOT, the flow goes to Step 340; if YES, the next step is to move the location of the cursor on the device's display based on the distance and direction of the object moving around the touch-pad according to relative coordinate positioning (Step 330). If a user's finger or a touch pen moves around the touch-pad, the cursor on the display is moved a proportionate distance, the proportion is normally designed within a specific range, allowing the user to make precise movements of the cursor towards the targeted location. Relative coordinate positioning means the location coordinates of the touch-pad are not directly related to the location coordinates of the display screen, the location and movement of the cursor on the display screen is irrelevant to the location of the object on the touch-pad, only the movement of the object on the touch-pad matters. When the cursor is moved to a targeted location on the display screen, the invention detects if an input button of the electronic device is pressed (Step 340), if NOT, meaning that the user is not attempting to execute the command pointed at by the cursor on the display, then the flow goes to Step 300 for continuously detecting if an object contacts the touch-pad and determines to move the cursor in relative or in absolute coordinate positioning. If the input button of the electronic device is pressed, a user intends to execute a selected item as pointed by the cursor on the display; the next step is to execute the command of a selected item pointed by the cursor on the display (Step 350). The touch-pad control method continuously goes to Step 300 for determining whether to move the cursor in relative or in absolute coordinate positioning during the command execution or switches the electronic device to a power off mode after the completion of the flow.

The execution of Step 340 triggers subsequent flows similar to those steps of 160, 170 and 180 as shown in FIG. 2 and FIG. 3; therefore, no further description is needed.

The above method is able to control the touch-pad in relative coordinate positioning and allow the cursor to move toward a target item at once, if the target item is close to the edge of the screen or to some other location on the screen where is unable to be accurately pointed at by the user at the first time, which means that when a user points at a location on the screen, there sometimes is a small range between the actual location of the target and the cursor location. Therefore, the invention enables a user to make small movements toward the target. Moreover, when the touch-pad is correspondent with the screen size according to the method of the invention in absolute coordinate positioning, there sometimes is a small range between the actual location of the target and the cursor location, namely, the touch-pad is correspondent with the screen with a smaller size than its actual area to allow the cursor to have longer moving distance, so when a user moves the cursor towards a target location near the edge of the screen at the first time, there will be no risk of collision with the edge of the touchpad. The invention achieves the objective of solving the user's difficulty in accurately pointing the cursor at a target near the edge of the screen.

In accordance with the two different flows above, the input button is positioned either under the touch-pad or inside the lower surface against the touch-pad. The peripheral of touch-pad is equipped with a movement control area and an electronic device is a notebook computer in a preferred embodiment of the invention. By using the above two methods, the invention continuously detects if there is any contact with the touch-pad. The invention adjusts the location of the cursor on the display screen when such contact is detected. If the object re-contacts the touch-pad with a signal request for quick cursor movement, the invention enables the cursor to be directly moved to a corresponding location on the screen in absolute coordinate positioning. If the user feels the distance between the cursor and the target location is too long, the user is able to lift the object, slightly adjust the distance and re-point the object on the touch-pad. After the adjustment, if the object is close to the target location, the user is allowed to directly make slightly adjustment on the touch-pad and the request of quickly moving the cursor is triggered. Generally, a computer display size is larger than the touch-pad and their location coordinates are correspondent with each other in absolute coordinate positioning, so that the enlargement ratio of the moving distance of the object to that of the cursor is rather big to ensure faster cursor movement. The absolute coordinate positioning method is applied to move the cursor near the selection item (ICON), nevertheless, it would be difficult for a user to accurately point the cursor at the selection item in case that the selection item is pretty small. Therefore, as long as the object (e.g., a finger, stylus, etc.) is still touching the touch-pad without being lifted, the movement of the object triggers the signal request for quickly moving the cursor, and then, the invention applies the relative coordinate positioning method to calculate the distance of the object movement and move the cursor in the same direction as the object movement over a scaled distance. The invention enables a user to accurately move the cursor to a target at a closer distance range and press the button to activate the item under the cursor on the screen. Consequently, the invention enables the cursor to be moved quickly and accurately at a time from any location to another location on the display screen, in addition, the invention is able to achieve the effects of fast cursor moving on the screen and easy icon pointing without the problems and inconvenience caused to a user to repeatedly drag the cursor and rub against the touch-pad. The touch-pad activates an input for quick cursor movement and executes relevant commands and calculations in absolute coordinate positioning each time when the object is lifted and re-pointed at the same location on the touch-pad. Namely, a input for quick cursor movement is triggered when the object contacts the touch-pad and no any clicking motion is made by the user for item selection, the invention enables the object touching the touch-pad to be correspondent with the location of a target on the screen in absolute coordinate positioning, or if the input for quick cursor movement does not exist, the distance and direction of the input motion around the touch-pad corresponds to the location of the cursor on the device's display in relative coordinate positioning. The aforementioned step of detecting if an input for quickly moving the cursor exists is a monitoring process in a certain time span after the object is moved away from the touch-pad, i.e., the invention continuously monitors if there is an input for trigging the quick cursor movement when the object is removed from contacting the touch-pad; if the time is short, the invention applies the relative coordinate positioning method for location mapping to satisfy the user's accurate cursor “movement” toward a target item; if the period is longer, then the invention applies the absolute coordinate positioning method for coordinate mapping. In view of the above methods, a user is able to use the cursor on the screen to easily aim at a target point by moving a small distance on the touch-pad at a time. If the target item is close to the edge of the screen or to some other location on the screen where is unable to be accurately pointed at by the user at the first time, which means that when a user points at a location on the screen, there sometimes is a small range between the actual location of the target and the cursor location. If the user moves the object around the touch-pad towards the aimed item, the object may be near the edge of the touch-pad but is still unable to accurately reach the aimed item, as the cursor moving distance is bigger and the ratio of the touch-pad to the screen is smaller. To solve the problem, the invention enables the object to hit the edge of the touch-pad and then allows the user to lift the object and re-connect with the touch-pad, the invention then applies the absolute coordinate positioning for location mapping, thereby enabling the cursor to be moved to the edge of the screen.

Another process flow based on the method of the invention is to leave a certain distance on the edge when the touch-pad is correspondent with the screen size in absolute coordinate positioning, namely, the touch-pad is correspondent with the screen with a smaller size than its actual area to allow the cursor to have longer moving distance, so when a user used an object (a finger or a touch pen, etc.) to move the cursor towards a target location near the edge of the screen, there will be no risk of collision with the edge of the touchpad.

While the invention has been described by way of example and in terms of preferred embodiment, it is to be understood that the invention is not limited to these particular applications. To the contrary, it is intended to cover various modifications and similar arrangements (as would be apparent to those in the industry). Therefore, the scope of the appended claims should be accorded the broadest interpretation so as to encompass all such modifications and similar arrangements.

What is claimed is:

1. A touch-pad cursor control method, having a touch-pad placed in an electronic device, comprised of the following steps:
a step of detecting if an object contacts said touch-pad;
a step of calculating the location coordinates of said object touching said touch-pad;
a step of determining if an input for quick cursor movement exists;
a step of detecting if an input button of said electronic device is pressed; and
a step of executing a command based on an item pointed by said cursor on the display.

2. The touch-pad cursor control method as claimed in claim 1, wherein said control method further includes a step of properly enlarging the ratio between said touch-pad dragging range and said cursor dragging distance on said display, when said input button of said electronic device is pressed and said object is moved on said touch-pad again.

3. Said touch-pad cursor control method as claimed in claim 1, wherein said control method further is comprised of a step of dragging said cursor on said display in absolute coordinate positioning, when said input button of said electronic device is pressed and said object is moved on said touch-pad again.

4. Said touch-pad cursor control method as claimed in claim 1, wherein said step of determining if an input for quick cursor movement exists finds no signal is to move the location of said cursor on said device's display based on the distance and direction of said object moving around said touch-pad in relative coordinate positioning, wherein said distance and direction of cursor movement and said ratio of said distance and direction on said touch-pad to that of said display is obviously less than said ratio of the width and the length of said display to that of said touch-pad, in order to achieve more precise results.

5. Said touch-pad cursor control method as claimed in claim 4, wherein said relative coordinate positioning means that the location coordinates of said touch-pad are not directly related to the location coordinates of said screen, the position and movement of said cursor on said display are both independent of the position of said object on said touch-pad, but is rather dependent on the movement of said object on said touch-pad.

6. Said touch-pad cursor control method as claimed in claim 1, wherein said step of determining if a input for quick cursor movement is triggered by a user enabling move said object to move around said touch-pad at once, such motion is able to be made by a stand-alone key button or specific motion made by a user on touch-pad.

7. Said touch-pad cursor control method as claimed in claim 1, wherein said electronic device is a notebook PC.

8. Said touch-pad cursor control method as claimed in claim 1, wherein said object is either a finger or a touch pen.

9. Said touch-pad cursor control method as claimed in claim 1, wherein said touch-pad allows a movement control area to be installed on the peripheral thereof.

10. Said touch-pad cursor control method as claimed in claim 1, wherein said input button is located either on the bottom of said touch-pad or against the lower surface inside said touch-pad.

11. Said touch-pad cursor control method as claimed in claim 1, wherein said absolute coordinate positioning is to multiply each location coordinate of said touch-pad by a specific enlargement ratio to the corresponding location of said cursor on said display, in addition, the enlargement ratio is determined by respective lengths and widths of said touch-pad and of said display.

12. Said touch-pad cursor control method as claimed in claim 1, wherein said absolute coordinate positioning means that the location of said cursor moving around said display is determined by the actual location of said object on said touch-pad.

13. A touch-pad cursor control method, wherein said touch-pad is placed in an electronic device and said method comprising the following steps:
a step of detecting if an object contacts said touch-pad;
a step of calculating the location coordinates of an object touching said touch-pad;
a step of determining if an input for quick cursor movement exists;
a step of canceling said signal for quick cursor movement, and then, moving said cursor around said display of said electronic device to the location corresponding to said object touching said touch-pad in absolute coordinate positioning;
a step of detecting if an input button of the electronic device is pressed; and
a step of executing an item pointed by said cursor on the display and inputted by the user;
wherein the absolute coordinate positioning is to multiply the touch-pad coordinates by an increasing proportion to the corresponding location of said cursor on said display, in addition, the enlargement ratio is determined by respective lengths and widths of said touch-pad and of said display.

14. Said touch-pad cursor control method as claimed in claim 13, wherein said control method further includes a step of properly enlarging the ratio between said touch-pad dragging range and said cursor dragging distance on said display, when said input button of said electronic device is pressed and said object is moved on said touch-pad again.

15. Said touch-pad cursor control method as claimed in claim 13, wherein said control method further is comprised of a step of using absolute coordinate positioning to drag the cursor on the display, when said input button of said electronic device is pressed and said object is moved on said touch-pad again.

16. Said touch-pad cursor control method as claimed in claim 13, wherein said touch-pad has a movement control area positioned on the peripheral thereof.

17. Said touch-pad cursor control method as claimed in claim 13, wherein said input button is located either on the bottom of said touch-pad or against the lower surface inside said touch-pad.

18. Said touch-pad cursor control method as claimed in claim 13, wherein said absolute coordinate positioning also enables the location of said cursor around said display to be determined by the actual location of said object on said touch-pad.

19. A touch-pad cursor control method, said touch-pad is placed in an electronic device and said control method is comprised of the following steps:
detecting if an object contacts said touch-pad;
detecting if said object contacts the location coordinates of said touch-pad, also moving the locations of said cursor around said display of said electronic device to the corresponding location of said object on said touch-pad in absolute coordinate positioning;
determining if said object is still in contact with said touch-pad;
moving said cursor on said display of said electronic device based on the distance and direction of said object manipulating said touch-pad in relative coordinate positioning;
detecting if an input button of the electronic device is pressed; and executing an item pressed by said cursor on the display.

20. Said touch-pad cursor control method as claimed in claim 19, wherein said control method further is comprised of a step of properly enlarging the ratio between said touch-pad dragging range and said cursor dragging distance on said display, when said input button of said electronic device is pressed and said object is moved on said touch-pad again.

21. Said touch-pad cursor control method as claimed in claim 19, wherein said control method is further comprised of a step using absolute coordinate positioning to drag said cursor on said display, when said input button of said electronic device is pressed and said object is moved on said touch-pad again.

22. Said touch-pad cursor control method as claimed in claim 19, wherein said electronic device is a notebook PC.

23. Said touch-pad cursor control method as claimed in claim 19, wherein said object is either a finger or a touch pen.

24. Said touch-pad cursor control method as claimed in claim 19, wherein said touch-pad allows a movement control area to be installed on the peripheral thereof.

25. Said touch-pad cursor control method as claimed in claim 19, wherein said input button is located either on the bottom of said touch-pad or against the lower surface inside said touch-pad.

26. Said touch-pad cursor control method as claimed in claim 19, wherein said absolute coordinate positioning is to scale each location coordinate of said touch-pad by a specific enlargement ratio to get a corresponding location of said cursor on said display, with the enlargement ratio determined by respective lengths and widths of said touch-pad and display.

27. Said touch-pad cursor control method as claimed in claim 19, wherein said absolute coordinate positioning means that the location of said cursor moving around said display is determined by the actual location of said object on said touch-pad.

28. Said touch-pad cursor control method as claimed in claim 19, wherein said relative coordinate positioning means that the location coordinates of said touch-pad are not directly related to the location coordinates of said screen, in addition, the location and movement of said cursor around said screen is independent of the location of said object on said touch-pad, but is rather dependent on the movement of said object on said touch-pad.
